(19) United States
(12) Patent Application Publication
(10) Pub. No.: US 2026/0285174 A1
(43) Pub. Date: Sep. 24, 2026

(54) CONTROL DEVICE, CONTROL METHOD, AND STORAGE MEDIUM FOR CONTACTLESS POWER TRANSMISSION SYSTEM

(71) Applicant: HONDA MOTOR CO., LTD., Tokyo (JP)

(72) Inventor: Kosuke KAJITA, Tokyo (JP)

(73) Assignee: HONDA MOTOR CO., LTD., Tokyo (JP)

(21) Appl. No.: 19/567,318

(22) Filed: Mar. 16, 2026

(30) Foreign Application Priority Data
Mar. 19, 2025 (JP) 2025-044462

(51) Int. Cl. B60L 53/124; B60L 53/122; B60L 53/30; B60L 53/36; B60L 53/38

(52) U.S. Cl. CPC B60L 53/124; B60L 53/122; B60L 53/36; B60L 53/38; B60L 53/32

(57) ABSTRACT

A control device for a contactless power transmission system that transmits power in a contactless manner between a vehicle-side unit and a ground-side unit, the vehicle-side unit including a vehicle-side coil mounted on a vehicle that includes a battery, the ground-side unit including a ground-side coil provided outside the vehicle, includes a processor configured to acquire, when a metal foreign object is present on a surface of the ground-side unit, position information on the metal foreign object, move the vehicle based on the position information on the metal foreign object to change a relative position between the metal foreign object and the vehicle-side unit, and energize the vehicle-side coil with an alternating current after or during movement of the vehicle.

### CROSS-REFERENCE TO RELATED APPLICATIONS

This application is based on and claims priority under 35 USC 119 from Japanese Patent Application No. 2025-044462 filed on Mar. 19, 2025, the entire content of which is incorporated herein by reference.

### TECHNICAL FIELD

The present disclosure relates to a control device, a control method, and a non-transitory storage medium storing a program for a contactless power transmission system that transmits power between a vehicle-side unit and a ground-side unit in a contactless manner.

### BACKGROUND ART

In recent years, in order to allow more people to access affordable, reliable, sustainable, and advanced energy, researches and developments have been conducted on charging and power supply in a mobility mounted with a secondary battery that contributes to an increase in energy efficiency. For example, CN110103744A discloses a technique for performing contactless power transmission between a power transmission unit provided on the ground and a power reception unit mounted on a vehicle.

In the technique disclosed in CN110103744A, when a metal foreign object is present on the power transmission unit provided on the ground, a coil in the power transmission unit is energized with a high-frequency pulse signal to move and remove the foreign object.

### SUMMARY OF INVENTION

In CN110103744A, since a direction of a magnetic field from the coil provided on the ground is always the same, the foreign object may not move in some cases.

Aspect of non-limiting embodiments of the present disclosure relates to providing a control device, a control method, and a non-transitory storage medium storing a program for a contactless power transmission system, which can improve reliability of removing a foreign object present on a surface of a ground-side unit.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a control device for a contactless power transmission system that transmits power in a contactless manner between a vehicle-side unit and a ground-side unit, the vehicle-side unit including a vehicle-side coil mounted on a vehicle that includes a battery, the ground-side unit including a ground-side coil provided outside the vehicle, the control device including a processor configured to acquire, when a metal foreign object is present on a surface of the ground-side unit, position information on the metal foreign object, move the vehicle based on the position information on the metal foreign object to change a relative position between the metal foreign object and the vehicle-side unit, and energize the vehicle-side coil with an alternating current after or during movement of the vehicle.

According to an aspect of the present disclosure, there is provided a control method for a contactless power transmission system that transmits power in a contactless manner between a vehicle-side unit and a ground-side unit, the vehicle-side unit including a vehicle-side coil mounted on a vehicle that includes a battery, the ground-side unit including a ground-side coil provided outside the vehicle, the control method including acquiring, when a metal foreign object is present on a surface of the ground-side unit, position information on the metal foreign object, moving the vehicle based on the position information on the metal foreign object to change a relative position between the metal foreign object and the vehicle-side unit, and energizing the vehicle-side coil with an alternating current after or during movement of the vehicle.

According to an aspect of the present disclosure, there is provided a non-transitory computer-readable storage medium storing a control program for a computer to perform processing, the computer configured to control a contactless power transmission system that transmits power in a contactless manner between a vehicle-side unit and a ground-side unit, the vehicle-side unit including a vehicle-side coil mounted on a vehicle that includes a battery, the ground-side unit including a ground-side coil provided outside the vehicle, the processing including acquiring, when a metal foreign object is present on a surface of the ground-side unit, position information on the metal foreign object, moving the vehicle based on the position information on the metal foreign object to change a relative position between the metal foreign object and the vehicle-side unit, and energizing the vehicle-side coil with an alternating current after or during movement of the vehicle.

According to the present disclosure, it is possible to increase reliability of removing a foreign object present on a surface of a ground-side unit.

### BRIEF DESCRIPTION OF DRAWINGS

Exemplary embodiment(s) of the present invention will be described in detail based on the following figures, wherein:

FIG. 1 is a schematic configuration diagram of a contactless power transmission system according to an exemplary embodiment of the present invention;

FIG. 2 is a functional block diagram of the contactless power transmission system;

FIG. 3 is a functional block diagram of a control device mounted on a vehicle;

FIG. 4 is a schematic side view of a ground-side unit and a vehicle-side unit when foreign object removal control is executed;

FIG. 5 is a flowchart showing an example of processing of the foreign object removal control by a processor of the vehicle; and

FIG. 6 is a continuation of the flowchart in FIG. 5.

### DESCRIPTION OF EMBODIMENTS

Hereinafter, an embodiment of a control device, a control method, and a non-transitory storage medium storing a program for a contactless power transmission system of the present disclosure will be described with reference to the accompanying drawings. The drawings are viewed in directions of reference signs. In the present specification and the like, in order to simplify and clarify the description, in the drawings, a front side of a vehicle is shown as Fr, a rear side is shown as Rr, a left side is shown as L, a right side is shown as R, an upper side is shown as U, and a lower side is shown as D.

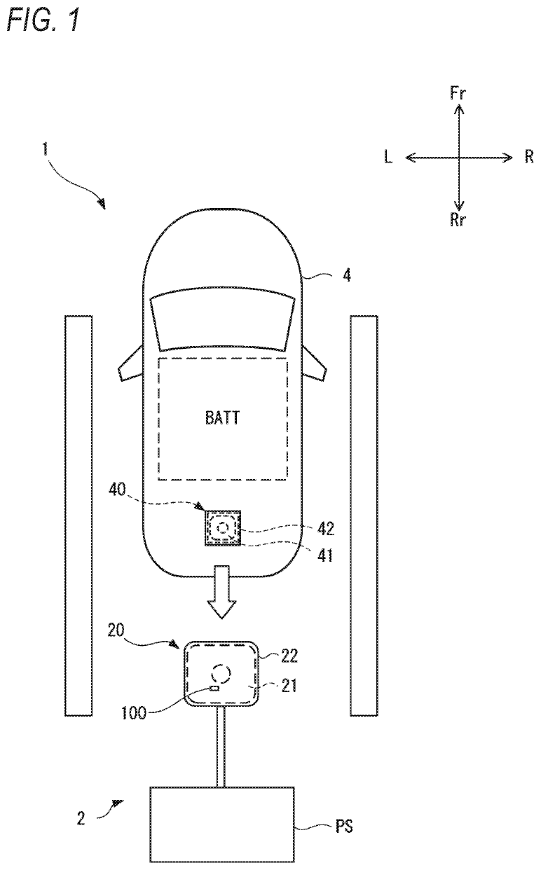

FIG. 1 is a schematic configuration diagram of a contactless power transmission system 1 according to an exemplary embodiment of the present invention. The contactless power transmission system 1 includes ground-side equipment 2 where a ground-side unit 20 is provided, and a vehicle 4 where a vehicle-side unit 40 is mounted. In the contactless power transmission system 1, contactless power transmission for transmitting power in a contactless manner is performed between the ground-side unit 20 and the vehicle-side unit 40, using magnetic coupling between coils of, for example, a magnetic resonance method or an electromagnetic induction method.

The contactless power transmission includes power transmission from the ground-side unit 20 to the vehicle-side unit 40 and power transmission from the vehicle-side unit 40 to the ground-side unit 20. The power transmission from the ground-side unit 20 to the vehicle-side unit 40 corresponds to charging of a battery BATT mounted on the vehicle 4, and the power transmission from the vehicle-side unit 40 to the ground-side unit 20 corresponds to power supply from the battery BATT to the outside of the vehicle 4.

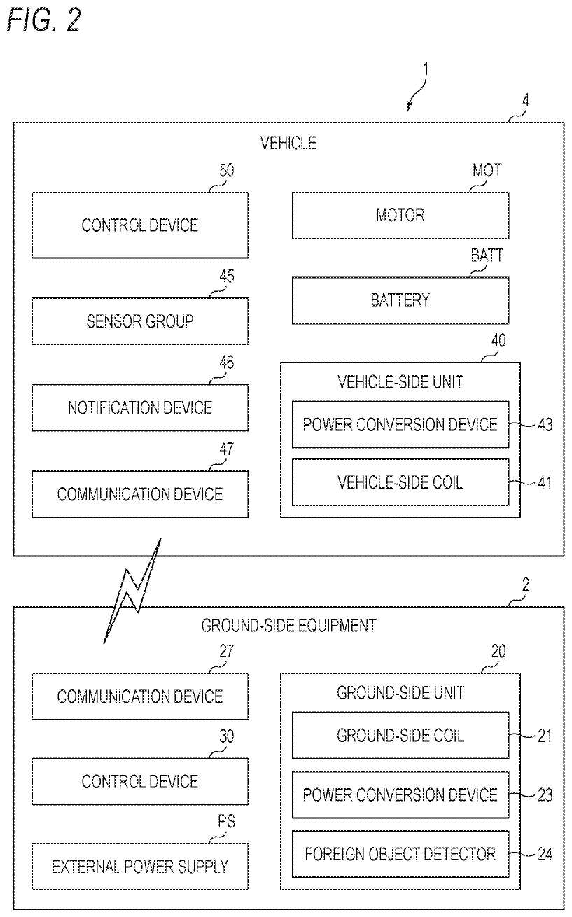

The ground-side equipment 2 is provided in a predetermined parking space or the like. As shown in FIG. 2, the ground-side equipment 2 includes the ground-side unit 20, a communication device 27 that can communicate with the vehicle 4, a control device 30 that controls the ground-side unit 20, and a power supply device PS connected to an external power system such as a commercial power supply.

The ground-side unit 20 includes a ground-side coil 21 provided on the ground, a resin pad 22 covering the ground-side coil 21, a power conversion device 23 that converts AC power supplied from the power supply device PS into high-frequency AC power and supplies the converted high-frequency AC power to the ground-side coil 21, and a foreign object detector 24 that detects a metal foreign object 100 present on a surface of the pad 22. A shape of the ground-side coil 21 is, for example, circular in a plan view, but is not limited thereto and may be elliptical, square, or rectangular.

The foreign object detector 24 includes, for example, a coil array in which a plurality of foreign object detection coils (not shown) are dispersedly distributed along a substantially flat plane and partially or entirely embedded in the pad 22. The foreign object detector 24 detects information on the foreign object 100 on a surface of the ground-side unit 20 (that is, an upper surface of the pad 22) based on a manner of change in an oscillation waveform signal supplied from an oscillator to each of the foreign object detection coils. The information on the foreign object 100 detected by the foreign object detector 24 is, for example, information on presence or absence of the foreign object 100, position information on the foreign object 100, and size information on the foreign object 100.

The communication device 27 is a communication interface that performs wireless communication with a communication device 47 of the vehicle 4. For the wireless communication, for example, Wi-Fi (registered trademark) or Bluetooth (registered trademark) can be used.

The control device 30 includes, for example, a processor and a memory, and performs overall control of the ground-side equipment 2. The processor is configured as one or a plurality of electric circuits in which circuit elements such as semiconductor elements are combined. The memory functions as a storage unit and includes a random access memory (RAM) required for operating the processor, a read only memory (ROM) that stores programs and data, and the like.

The vehicle 4 is an electric vehicle whose battery BATT can be charged by power supplied from the outside, and is, for example, a battery electric automobile or a plug-in hybrid vehicle. When the battery BATT is charged, the vehicle-side unit 40 receives power transmitted from the ground-side unit 20 in a contactless manner and stores the received power in the battery BATT. The battery BATT is, for example, a lithium ion battery or a nickel-metal hydride battery. The vehicle 4 can travel by driving a motor MOT, which is a drive source, using the power stored in the battery BATT. The vehicle 4 may be allowed to supply the power stored in the battery BATT to the outside. Specifically, the vehicle 4 may transmit power from the vehicle-side unit 40 to the ground-side unit 20 in a contactless manner.

The vehicle 4 has an autonomous parking function for autonomously moving to and parking in a predetermined parking space. The autonomous parking function operates, for example, in response to a request from an occupant. When the autonomous parking function is operated in the vicinity of the parking space where the ground-side equipment 2 is provided, the vehicle 4 autonomously moves toward a target parking position. The target parking position is a position where the ground-side unit 20 and the vehicle-side unit 40 face each other. The target parking position may be a position where contactless power transmission efficiency is maximized. In other wors, the target parking position may be a position where centers of the ground-side unit 20 and the vehicle-side unit 40 match each other.

As shown in FIGS. 1 and 2, the vehicle 4 includes the battery BATT, the motor MOT serving as the drive source, the vehicle-side unit 40, a sensor group 45, a notification device 46, the communication device 47, and a control device 50.

The vehicle-side unit 40 includes a vehicle-side coil 41 mounted on a lower portion of the vehicle 4, a resin pad 42 covering the vehicle-side coil 41, and a power conversion device 43. A shape of the vehicle-side coil 41 is, for example, circular in a plan view, but is not limited thereto and may be elliptical, square, or rectangular.

The power conversion device 43 is implemented as an inverter including a switching element such as a transistor. For example, when the battery BATT is charged, the power conversion device 43 rectifies high-frequency AC power received by the vehicle-side coil 41 and outputs the rectified AC power to the battery BATT. When power is transmitted from the battery BATT to the outside of the vehicle 4, the power conversion device 43 converts DC power of the battery BATT into high-frequency AC power and supplies the AC power to the vehicle-side coil 41.

The sensor group 45 acquires various detection values used for controlling the vehicle 4. The sensor group 45 includes, for example, a camera (image sensor) and a sonar for acquiring surrounding information of the vehicle 4. The sensor group 45 also includes, for example, a wheel sensor, a positioning sensor, and a steering angle sensor for acquiring state information on the vehicle 4. The sensor group 45 may also include other sensors, for example, radar and light detection and ranging (LiDAR) for acquiring the surrounding information of the vehicle 4.

The notification device 46 is an output destination of notification processing by the control device 50, and notifies the occupant of the vehicle 4 of predetermined information. The notification device 46 is, for example, a display (also including a head-up display) or a speaker provided in the vehicle 4, and notifies the occupant of the predetermined information by video or audio. The notification device 46 may also be a user terminal such as a smartphone or a tablet terminal owned by the occupant.

The communication device 47 is a communication interface that performs wireless communication with the communication device 27 of the ground-side equipment 2. For the wireless communication, for example, Wi-Fi (registered trademark) or Bluetooth (registered trademark) can be used. The communication device 47 can also perform wireless communication via a network using a mobile communication network such as “4G” or “5G”.

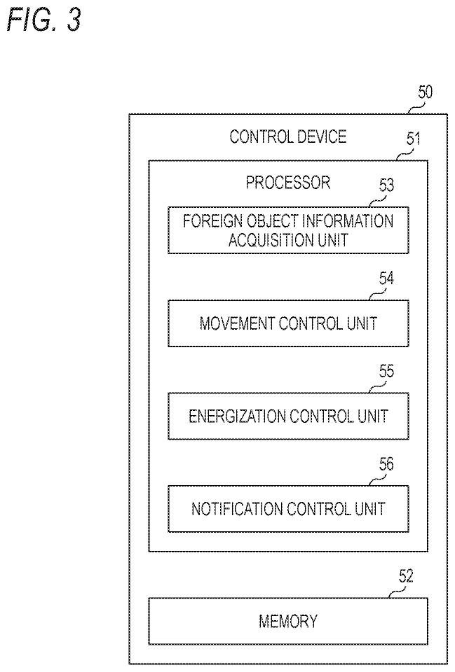

As shown in FIG. 3, the control device 50 is, for example, an electronic control unit (ECU) including a processor 51 and a memory 52. The processor 51 is configured as one or a plurality of electric circuits in which circuit elements such as semiconductor elements are combined. The memory 52 functions as a storage unit and includes a RAM required for operating the processor 51, a ROM that stores programs and data, and the like.

The processor 51 includes, as functional configurations implemented by reading and executing the programs stored in the memory 52, a foreign object information acquisition unit 53, a movement control unit 54, an energization control unit 55, and a notification control unit 56 in foreign object removal control to be described later. A plurality of processors 51 may be provided by being subdivided into various functions.

The foreign object information acquisition unit 53 acquires the information on the presence or absence of the foreign object 100 on the surface of the ground-side unit 20, the position information on the foreign object 100, and the size information on the foreign object 100.

The movement control unit 54 executes steering operation control, driving force control, braking force control, and the like to implement autonomous movement of the vehicle 4, specifically, autonomous parking. The movement control unit 54 executes various types of control based on, for example, various detection values detected by the sensor group 45, map information, and/or parking information when parking was performed in the past.

The movement control unit 54 executes various types of control related to the movement of the vehicle 4 while acquiring relative position information on the vehicle-side unit 40, the ground-side unit 20, and the foreign object 100 based on an image or the like captured by the camera in the sensor group 45. When the vehicle 4 moves until the ground-side unit 20 is located under a floor of the vehicle 4 and images of the ground-side unit 20 and the foreign object 100 cannot be captured by the camera mounted on the vehicle 4, the movement control unit 54 estimates the relative position information on the vehicle-side unit 40, the ground-side unit 20, and the foreign object 100 while referring to an operation amount of, for example, a steering operation, a drive operation, and a brake operation (control operation amount).

The energization control unit 55 controls energization of the vehicle-side coil 41 from the battery BATT by controlling the power conversion device 43 in the foreign object removal control.

The notification control unit 56 issues a predetermined notification to the occupant via the notification device 46.

Next, the foreign object removal control by the processor 51 of the control device 50 will be described. When the contactless power transmission is performed in a state in which the metal foreign object 100 is present on the surface of the ground-side unit 20, an eddy current is generated in the foreign object 100 and heat the foreign object 100, which may cause a the foreign object 100 to reach a high temperature. In addition, heat generation of the foreign object 100 may increase a power transmission loss. In order to ensure safety and reduce the power transmission loss, it is required to remove the foreign object 100 before performing the contactless power transmission.

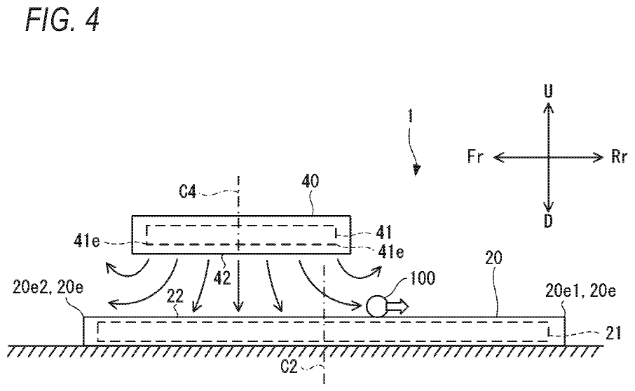

As shown in FIG. 4, when the vehicle-side coil 41 is energized with an alternating current, a magnetic field penetrating a center of the vehicle-side coil 41 as indicated by a solid arrow in the drawing is generated. When the magnetic field is generated from the vehicle-side coil 41 in the state in which the foreign object 100 is present on the surface of the ground-side unit 20, an eddy current is generated in the foreign object 100 by the magnetic field, and a Lorentz force (white arrow in the drawing) is generated in the foreign object 100. The generated Lorentz force moves the foreign object 100 in a direction in which the Lorentz force acts.

Various types of processing of the foreign object removal control by the processor 51 in the present embodiment are executed before the contactless power transmission is executed, in other words, before the ground-side coil 21 and the vehicle-side coil 41 are magnetically coupled. As processing of the foreign object removal control, the processor 51 moves the vehicle 4 to a predetermined relative position with respect to the foreign object 100 and energizes the vehicle-side coil 41 with the alternating current to generate the magnetic field. Since the Lorentz force is generated in the foreign object 100 due to the generation of the magnetic field, the foreign object 100 moves and is removed from the surface of the ground-side unit 20. In this way, the foreign object removal control in the present embodiment is implemented using the vehicle-side unit 40 that can change the relative position with respect to the foreign object 100.

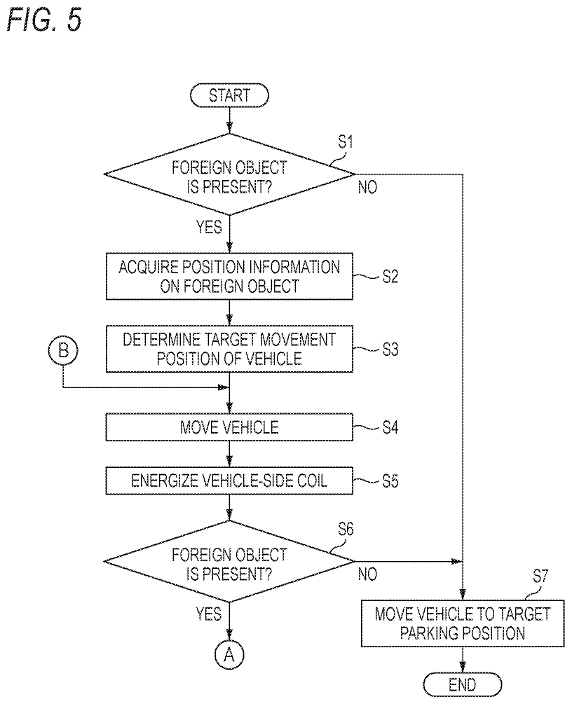

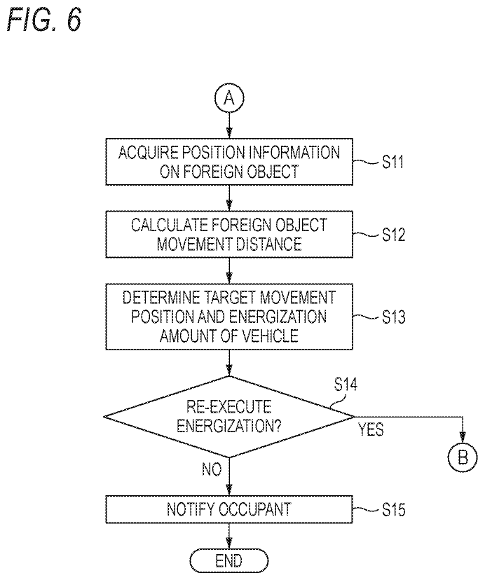

FIGS. 5 and 6 are flowcharts showing an example of the processing of the foreign object removal control by the processor 51. The processing of the foreign object removal control is executed when autonomous parking of the vehicle 4 is performed in the parking space where the ground-side equipment 2 is provided. For example, when the autonomous parking function is turned on in the vicinity of the parking space, the processor 51 executes the processing in the flowchart before moving the vehicle 4 to the target parking position by autonomous parking.

The processor 51 first determines whether the foreign object 100 is present on the surface of the ground-side unit 20 (step S1). For example, when the foreign object detector 24 of the ground-side equipment 2 detects the foreign object 100 in a state in which the ground-side equipment 2 and the vehicle 4 can communicate, the ground-side equipment 2 transmits information indicating that the foreign object 100 is present to the vehicle 4. The processor 51 acquires the information indicating that the foreign object 100 is present via the communication device 47 and determines that the foreign object 100 is present. On the other hand, when the foreign object detector 24 of the ground-side equipment 2 does not detect the foreign object 100 in the state in which the ground-side equipment 2 and the vehicle 4 can communicate, the processor 51 does not acquire the information on the foreign object 100 and thus determines that the foreign object 100 is not present.

When it is determined that the foreign object 100 is not present (step S1: NO), the processor 51 executes the autonomous parking for moving the vehicle 4 to the target parking position (step S7). The target parking position is, for example, a position where a central axis C2 of the ground-side coil 21 and a central axis C4 of the vehicle-side coil 41 match each other, and is a position where power transmission efficiency is highest.

When it is determined that the foreign object 100 is present (step S1: YES), the processor 51 acquires the position information on the foreign object 100 on the surface of the ground-side unit 20 (step S2). The foreign object detector 24 of the ground-side equipment 2 can detect the position information on the foreign object 100, and the processor 51 acquires the position information on the foreign object 100 by communication and stores the position information in the memory 52. When the foreign object detector 24 can detect the size information on the foreign object 100, the processor 51 may acquire the size information on the foreign object 100 in step S2.

In step S1 and step S2, the processor 51 may be configured to determine the presence or absence of the foreign object 100 and acquire the position information and the size information on the foreign object 100 using the camera or the like in the sensor group 45 without depending on the foreign object detector 24. In such a configuration, the processor 51 can determine the presence or absence of the foreign object 100 even when the communication between the ground-side equipment 2 and the vehicle 4 fails.

The processor 51 determines a target movement position of the vehicle 4 based on the position information on the foreign object 100 (step S3). Then, the processor 51 moves the vehicle 4 to the target movement position to change a relative position between the foreign object 100 and the vehicle-side coil 41 (step S4), and energizes the vehicle-side coil 41 with AC power after the movement of the vehicle 4 (step S 5).

When the target movement position of the vehicle 4 is described with reference to FIG. 4, the processor 51 sets, as the target movement position of the vehicle 4, a position where the foreign object 100 does not overlap the central axis C4 of the vehicle-side coil 41 when viewed in an axial direction of the vehicle-side coil 41. When the vehicle-side coil 41 is energized with the AC power in step S5, a Lorentz force is generated in the foreign object 100 by a magnetic field directed outward in a radial direction, and the foreign object 100 is moved to be pushed out in a direction away from the vehicle-side coil 41.

The processor 51 may set, as the target movement position of the vehicle 4, a position where at least a part of the foreign object 100 is located outside an outer peripheral edge 41e of the vehicle-side coil 41 when viewed in the axial direction of the vehicle-side coil 41. Accordingly, a horizontal component of the Lorentz force generated in the foreign object 100 increases, and thus the foreign object 100 can be effectively moved.

The processor 51 may set, as the target movement position of the vehicle 4, a position where the entire foreign object 100 is located outside the outer peripheral edge 41e of the vehicle-side coil 41 when viewed in the axial direction of the vehicle-side coil 41 (state in FIG. 4). Accordingly, the horizontal component of the Lorentz force generated in the foreign object 100 further increases, and thus a movement distance of the foreign object 100 can be increased.

The processor 51 may set the target movement position of the vehicle 4 based on the position of the foreign object 100 with respect to an outer peripheral edge 20e of the ground-side unit 20. Specifically, in the example shown in FIG. 4, the foreign object 100 is present at a position closer to a rear end edge 20e1 than to a front end edge 20e2 of the outer peripheral edge 20e of the ground-side unit 20. At this time, the processor 51 sets, as the target movement position of the vehicle 4, a position where the central axis C4 of the vehicle-side coil 41 is located not behind the foreign object 100 but in front of the foreign object 100. Accordingly, the foreign object 100 moves toward the closest rear end edge 20e1 of the outer peripheral edge 20e. Thus, it is possible to shorten the movement distance of the foreign object 100 required for moving to the outside of the ground-side unit 20.

In step S5, the processor 51 energizes the vehicle-side coil 41 with AC power of a predetermined energization amount at the time of initial energization.

An initial energization amount in step S5 may not be a predetermined value. For example, the processor 51 may change, based on the position of the foreign object 100 with respect to the outer peripheral edge 20e of the ground-side unit 20, the initial energization amount for energizing the vehicle-side coil 41. Specifically, the processor 51 may reduce the energization amount as the position of the foreign object 100 is closer to the outer peripheral edge 20e of the ground-side unit 20. When the position of the foreign object 100 is close to the outer peripheral edge 20e, it is not required to largely move the foreign object 100, and thus power consumption of the battery BATT can be reduced by reducing the energization amount.

The processor 51 may change the initial energization amount based on the size information on the foreign object 100. Specifically, the processor 51 may reduce the energization amount as the foreign object 100 is smaller. As the foreign object 100 is smaller, the foreign object 100 can be sufficiently moved even with a small energization amount, and thus the power consumption of the battery BATT can be reduced by reducing the energization amount.

After energizing the vehicle-side coil 41, the processor 51 determines whether the foreign object 100 is present on the surface of the ground-side unit 20 (step S6). The presence or absence of the foreign object 100 is determined in the same manner as in step S1. When it is determined that the foreign object 100 is not present (step S6: NO), the processor 51 determines that the foreign object 100 is removed and executes the autonomous parking for moving the vehicle 4 to the target parking position (step S7).

As described above, the processor 51 moves the vehicle 4 based on the position information on the foreign object 100 to change the relative position between the foreign object 100 and the vehicle-side coil 41. After the vehicle 4 moves, the processor 51 energizes the vehicle-side coil 41 with AC power. Since the vehicle-side unit 40 whose relative position with respect to the foreign object 100 can be changed is used to remove the foreign object 100, the magnetic field corresponding to the position of the foreign object 100 can be generated, and reliability of removing the foreign object 100 can be improved.

When it is determined in step S6 that the foreign object 100 is present (step S6: YES), the processor 51 acquires the position information on the foreign object 100 again (step S11). The position information on the foreign object 100 is acquired in the same manner as in step S2. The processor 51 stores the position information on the foreign object 100 acquired in step S6 in the memory 52.

Based on the position of the foreign object 100 before the energization and the position of the foreign object 100 after the energization, the processor 51 calculates the movement distance of the foreign object 100 moved by energizing the vehicle-side coil 41 (step S12).

Based on the position information on the foreign object 100 and the movement distance of the foreign object 100, the processor 51 determines the target movement position of the vehicle 4 and the energization amount of the alternating current for energizing the vehicle-side coil 41 (step S13). The target movement position is determined in the same manner as in step S3.

As for the energization amount determination, the processor 51 determines the energization amount by calculation based on the position information on the foreign object 100 and the movement distance of the foreign object 100 or by referring to a predetermined map. Specifically, when a distance between the foreign object 100 and the outer peripheral edge 20e of the ground-side unit 20 is long and the movement distance of the foreign object 100 is short, the processor 51 determines the energization amount of the alternating current to be an energization amount having the same magnitude as the initial energization amount (first energization amount). When the distance between the foreign object 100 and the outer peripheral edge 20e is long and the movement distance of the foreign object 100 is long, the processor 51 determines the energization amount of the alternating current to be the first energization amount or a second energization amount smaller than the first energization amount. When the distance between the foreign object 100 and the outer peripheral edge 20e is short and the movement distance of the foreign object 100 is short, the processor 51 determines the energization amount of the alternating current to be the second energization amount or a third energization amount smaller than the second energization amount. When the distance between the foreign object 100 and the outer peripheral edge 20e is short and the movement distance of the foreign object 100 is long, the processor 51 determines the energization amount of the alternating current to be the third energization amount smaller than the second energization amount.

In this way, since the processor 51 changes the energization amount for energizing the vehicle-side coil 41 based on the position of the foreign object 100 with respect to the outer peripheral edge 20e of the ground-side unit 20 after energization and the movement distance of the foreign object 100, it is possible to increase the energization amount when increasing a movement amount of the foreign object 100, or to reduce the power consumption of the battery BATT by reducing the energization amount when it is not required to increase the movement amount of the foreign object 100.

The processor 51 determines whether to re-energize the vehicle-side coil 41 (step S14). The determination by the processor 51 in step S14 is executed based on, for example, the movement distance of the foreign object 100.

Specifically, when the movement distance of the foreign object 100 is greater than a predetermined distance, it is expected that a weight of the foreign object 100 is not so large and the foreign object 100 can be removed with a small number of times of energization, and thus the processor 51 determines to re-execute the energization of the vehicle-side coil 41 (step S14: YES). On the other hand, when the movement distance of the foreign object 100 is equal to or less than the predetermined distance (the movement distance also includes zero), it is expected that the weight of the foreign object 100 is large and the number of times of energization is to be increased in order to remove the foreign object 100, and thus the processor 51 determines that the energization of the vehicle-side coil 41 is not to be executed (step S14: NO).

In step S14, the processor 51 may determine whether to re-execute the energization of the vehicle-side coil 41 further based on the position information on the foreign object 100 acquired in step S11, the energization amount determined in step S13, and/or the number of times of energization so far. For example, when the foreign object 100 is present at a close position within a predetermined distance from the outer peripheral edge 20e of the ground-side unit 20, the processor 51 may determine to re-execute the energization of the vehicle-side coil 41 regardless of the movement distance of the foreign object 100. When the energization amount determined in step S13 is greater than a predetermined amount, the processor 51 may determine not to execute the energization of the vehicle-side coil 41 regardless of the movement distance of the foreign object 100. When the number of times of energization so far reaches a predetermined number of times, the processor 51 may determine not to execute the energization of the vehicle-side coil 41 regardless of the movement distance of the foreign object 100.

When it is determined that the energization of the vehicle-side coil 41 is to be re-executed (step S14: YES), the processor 51 returns to steps S4 and S5 and executes the movement of the vehicle 4 and the energization of the vehicle-side coil 41. When it is determined, based on the energization of a second time, that the foreign object 100 is still present (step S6: YES), the processor 51 executes steps S11 to S14 again. In this way, the processor 51 repeatedly executes the movement processing and the energization processing of the vehicle 4 in the foreign object removal control.

When it is determined that the energization of the vehicle-side coil 41 is not to be executed (step S14: NO), the processor 51 notifies the occupant of the vehicle 4 of the information on the foreign object 100 (step S15). For example, the processor 51 uses the notification device 46 to notify information prompting the occupant to remove the foreign object 100 by hand. When the foreign object 100 cannot be removed by the foreign object removal control or it takes time to remove the foreign object 100, the occupant can be notified at an early stage, and it is possible to prevent the occupant from feeling discomfort due to repeated execution of the movement and energization of the vehicle 4.

The various types of processing in the flowcharts described above can be implemented by executing a program prepared in advance by a computer, specifically, the processor 51. The program is stored in a computer-readable storage medium and executed by being read from the storage medium. In addition, the program may be provided in a form stored in a non-transitory storage medium such as a flash memory, or may be provided via a network.

### Modification

When the foreign object 100 is present on the surface of the ground-side unit 20, the processor 51 may energize the vehicle-side coil 41 with AC power and energize the ground-side coil 21 of the ground-side unit 20 with an alternating current by performing wireless communication with the ground-side equipment 2. With such a configuration, the Lorentz force generated in the foreign object 100 can be increased.

Although one embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiments may be freely combined without departing from the gist of the invention.

For example, in the embodiment described above, the processor 51 energizes the vehicle-side coil 41 with the alternating current after the movement of the vehicle 4 in step S5, and alternatively, the vehicle-side coil 41 may be energized with the alternating current during the movement of the vehicle 4 as long as the vehicle-side coil 41 is sufficiently close to the foreign object 100.

In the present specification, at least the following matters are described. In the parentheses, the corresponding constituent elements and the like in the above embodiment are shown as examples, but the present invention is not limited thereto.

(1) A control device (control device 50) for a contactless power transmission system (contactless power transmission system 1) that transmits power in a contactless manner between a vehicle-side unit (vehicle-side unit 40) and a ground-side unit (ground-side unit 20), the vehicle-side unit including a vehicle-side coil (vehicle-side coil 41) mounted on a vehicle (vehicle 4) that includes a battery (battery BATT), the ground-side unit including a ground-side coil (ground-side coil 21) provided outside the vehicle, the control device including:
a processor (processor 51) configured to
   acquire, when a metal foreign object (foreign object 100) is present on a surface of the ground-side unit, position information on the metal foreign object (step S2),
   move the vehicle based on the position information on the metal foreign object to change a relative position between the metal foreign object and the vehicle-side unit (step S4), and
   energize the vehicle-side coil with an alternating current after or during movement of the vehicle (step S5).

According to (1), when the metal foreign object is present on the surface of the ground-side unit, the vehicle is moved based on the position information on the foreign object and the vehicle-side coil is energized with the alternating current, and thus a Lorentz force can be generated in the foreign object by a magnetic field generated in the vehicle-side coil to remove the foreign object from the surface of the ground-side unit. In this way, since the vehicle-side unit whose relative position with respect to the foreign object can be changed is used to remove the foreign object, the magnetic field corresponding to the position of the foreign object can be generated, and reliability of removing the foreign object can be improved.

(2) The control device for the contactless power transmission system according to (1), in which
the processor moves the vehicle to a position where at least a part of the metal foreign object is located outside an outer peripheral edge (outer peripheral edge 41e) of the vehicle-side coil when viewed in an axial direction of the vehicle-side coil.

According to (2), a horizontal component of the Lorentz force generated in the foreign object increases, and thus the foreign object can be effectively moved.

(3) The control device for the contactless power transmission system according to (1), in which
the processor moves the vehicle to a position where the metal foreign object is entirely located outside an outer peripheral edge of the vehicle-side coil when viewed in an axial direction of the vehicle-side coil.

According to (3), the horizontal component of the Lorentz force generated in the foreign object increases, and thus a movement distance of the foreign object can be increased.

(4) The control device for the contactless power transmission system according to any of (1) to (3), in which
the processor moves the vehicle based on a position of the metal foreign object with respect to an outer peripheral edge (outer peripheral edge 20e) of the ground-side unit.

According to (4), when the foreign object is moved and removed from the surface of the ground-side unit, the vehicle-side unit can be moved to a position where the movement distance of the foreign object is shortened.

(5) The control device for the contactless power transmission system according to any of (1) to (4), in which
the processor changes an energization amount for energizing the vehicle-side coil based on a position of the metal foreign object with respect to an outer peripheral edge (outer peripheral edge 20e) of the ground-side unit.

According to (5), it is possible to increase the energization amount when it is desired to increase a movement amount of the foreign object, or to reduce battery power consumption by decreasing the energization amount when the position of the foreign object is a position close to the outer peripheral edge of the ground-side unit.

(6) The control device for the contactless power transmission system according to any of (1) to (5), in which the processor
acquires, when the metal foreign object is present on the surface of the ground-side unit after energization of the vehicle-side coil, the position information on the metal foreign object again, and
notifies an occupant of the vehicle of information on the metal foreign object when a distance between a position of the metal foreign object before the energization of the vehicle-side coil and a position of the metal foreign object after the energization of the vehicle-side coil is equal to or less than a predetermined value.

For example, when a weight of the foreign object is large and the movement distance of the foreign object by the foreign object removal control is small, the number of times of foreign object removal control increases, and the occupant may feel discomfort. According to (6), since the occupant is notified of the information on the foreign object when the movement distance of the foreign object by energization is equal to or less than the predetermined value, it is possible to prevent the occupant from feeling discomfort due to repeated movement and energization of the vehicle.

(7) The control device for the contactless power transmission system according to any of (1) to (5), in which the processor
repeats, when the metal foreign object is present on the surface of the ground-side unit after energization of the vehicle-side coil, an execution of the movement of the vehicle and the energization of the vehicle-side coil, and
notifies an occupant of the vehicle of information on the metal foreign object when the metal foreign object is present on the surface of the ground-side unit after the movement of the vehicle and the energization of the vehicle-side coil are executed a predetermined number of times.

For example, when the weight of the foreign object is large and the foreign object is not removed even by the repeated foreign object removal control, the number of times of the foreign object removal control increases, and the occupant may feel discomfort. According to (7), since the occupant is notified of the information on the foreign object when the foreign object cannot be removed even by the repeated foreign object removal control, it is possible to prevent the occupant from feeling discomfort due to the movement and energization of the vehicle.

(8) The control device for the contactless power transmission system according to any of (1) to (7), in which the processor
repeats, when the metal foreign object is present on the surface of the ground-side unit after energization of the vehicle-side coil, an execution of the movement of the vehicle and the energization of the vehicle-side coil, and
changes an energization amount for energizing the vehicle-side coil based on a position of the metal foreign object with respect to an outer peripheral edge (outer peripheral edge 20e) of the ground-side unit after the energization of the vehicle-side coil and a distance between a position of the metal foreign object before the energization of the vehicle-side coil and a position of the metal foreign object after the energization of the vehicle-side coil.

According to (8), it is possible to increase the energization amount when the movement amount of the foreign object is increased, or to reduce the battery power consumption by reducing the energization amount when it is not required to increase the movement amount of the foreign object.

(9) The control device for the contactless power transmission system according to any of (1) to (8), in which
the processor energizes the vehicle-side coil and the ground-side coil with the alternating current when the metal foreign object is present on the surface of the ground-side unit.

According to (9), the Lorentz force generated in the foreign object can be increased.

(10) A control method for a contactless power transmission system that transmits power in a contactless manner between a vehicle-side unit and a ground-side unit, the vehicle-side unit including a vehicle-side coil mounted on a vehicle that includes a battery, the ground-side unit including a ground-side coil provided outside the vehicle, the control method including:
acquiring, when a metal foreign object is present on a surface of the ground-side unit, position information on the metal foreign object (step S2);
moving the vehicle based on the position information on the metal foreign object to change a relative position between the metal foreign object and the vehicle-side unit (step S4); and
energizing the vehicle-side coil with an alternating current after or during movement of the vehicle (step S5).

According to (10), since the vehicle-side unit whose relative position with respect to the foreign object can be changed is used to remove the foreign object, the magnetic field corresponding to the position of the foreign object can be generated, and reliability of removing the foreign object can be improved.

(11) A non-transitory computer-readable storage medium storing a control program for a computer (processor 51) to perform processing, the computer configured to control a contactless power transmission system that transmits power in a contactless manner between a vehicle-side unit and a ground-side unit, the vehicle-side unit including a vehicle-side coil mounted on a vehicle that includes a battery, the ground-side unit including a ground-side coil provided outside the vehicle, the processing including:
acquiring, when a metal foreign object is present on a surface of the ground-side unit, position information on the metal foreign object (step S2);
moving the vehicle based on the position information on the metal foreign object to change a relative position between the metal foreign object and the vehicle-side unit (step S4); and
energizing the vehicle-side coil with an alternating current after or during movement of the vehicle (step S5).

According to (11), since the vehicle-side unit whose relative position with respect to the foreign object can be changed is used to remove the foreign object, the magnetic field corresponding to the position of the foreign object can be generated, and reliability of removing the foreign object can be improved.

What is claimed is:

1. A control device for a contactless power transmission system that transmits power in a contactless manner between a vehicle-side unit and a ground-side unit, the vehicle-side unit including a vehicle-side coil mounted on a vehicle that includes a battery, the ground-side unit including a ground-side coil provided outside the vehicle, the control device comprising:
a processor configured to
acquire, when a metal foreign object is present on a surface of the ground-side unit, position information on the metal foreign object,
move the vehicle based on the position information on the metal foreign object to change a relative position between the metal foreign object and the vehicle-side unit, and
energize the vehicle-side coil with an alternating current after or during movement of the vehicle.

2. The control device for the contactless power transmission system according to claim 1, wherein
the processor moves the vehicle to a position where at least a part of the metal foreign object is located outside an outer peripheral edge of the vehicle-side coil when viewed in an axial direction of the vehicle-side coil.

3. The control device for the contactless power transmission system according to claim 1, wherein
the processor moves the vehicle to a position where the metal foreign object is entirely located outside an outer peripheral edge of the vehicle-side coil when viewed in an axial direction of the vehicle-side coil.

4. The control device for the contactless power transmission system according to claim 1, wherein
the processor moves the vehicle based on a position of the metal foreign object with respect to an outer peripheral edge of the ground-side unit.

5. The control device for the contactless power transmission system according to claim 1, wherein
the processor changes an energization amount for energizing the vehicle-side coil based on a position of the metal foreign object with respect to an outer peripheral edge of the ground-side unit.

6. The control device for the contactless power transmission system according to claim 1, wherein the processor
acquires, when the metal foreign object is present on the surface of the ground-side unit after energization of the vehicle-side coil, the position information on the metal foreign object again, and
notifies an occupant of the vehicle of information on the metal foreign object when a distance between a position of the metal foreign object before the energization of the vehicle-side coil and a position of the metal foreign object after the energization of the vehicle-side coil is equal to or less than a predetermined value.

7. The control device for the contactless power transmission system according to claim 1, wherein the processor
repeats, when the metal foreign object is present on the surface of the ground-side unit after energization of the vehicle-side coil, an execution of the movement of the vehicle and the energization of the vehicle-side coil, and
notifies an occupant of the vehicle of information on the metal foreign object when the metal foreign object is present on the surface of the ground-side unit after the movement of the vehicle and the energization of the vehicle-side coil are executed a predetermined number of times.

8. The control device for the contactless power transmission system according to claim 1, wherein the processor
repeats, when the metal foreign object is present on the surface of the ground-side unit after energization of the vehicle-side coil, an execution of the movement of the vehicle and the energization of the vehicle-side coil, and
changes an energization amount for energizing the vehicle-side coil based on a position of the metal foreign object with respect to an outer peripheral edge of the ground-side unit after the energization of the vehicle-side coil and a distance between a position of the metal foreign object before the energization of the vehicle-side coil and a position of the metal foreign object after the energization of the vehicle-side coil.

9. The control device for the contactless power transmission system according to claim 1, wherein
the processor energizes the vehicle-side coil and the ground-side coil with the alternating current when the metal foreign object is present on the surface of the ground-side unit.

10. A control method for a contactless power transmission system that transmits power in a contactless manner between a vehicle-side unit and a ground-side unit, the vehicle-side unit including a vehicle-side coil mounted on a vehicle that includes a battery, the ground-side unit including a ground-side coil provided outside the vehicle, the control method comprising:
acquiring, when a metal foreign object is present on a surface of the ground-side unit, position information on the metal foreign object;
moving the vehicle based on the position information on the metal foreign object to change a relative position between the metal foreign object and the vehicle-side unit; and
energizing the vehicle-side coil with an alternating current after or during movement of the vehicle.

11. A non-transitory computer-readable storage medium storing a control program for a computer to perform processing, the computer configured to control a contactless power transmission system that transmits power in a contactless manner between a vehicle-side unit and a ground-side unit, the vehicle-side unit including a vehicle-side coil mounted on a vehicle that includes a battery, the ground-side unit including a ground-side coil provided outside the vehicle, the processing comprising:
acquiring, when a metal foreign object is present on a surface of the ground-side unit, position information on the metal foreign object;
moving the vehicle based on the position information on the metal foreign object to change a relative position between the metal foreign object and the vehicle-side unit; and
energizing the vehicle-side coil with an alternating current after or during movement of the vehicle.
